(19) United States
(12) Patent Application Publication
(10) Pub. No.: US 2025/0322705 A1
(43) Pub. Date: Oct. 16, 2025

(54) VEHICLE

(71) Applicant: TOYOTA JIDOSHA KABUSHIKI KAISHA, Toyota-shi (JP)

(72) Inventor: Masayuki KISHITA, Nisshin-shi (JP)

(73) Assignee: TOYOTA JIDOSHA KABUSHIKI KAISHA, Toyota-shi (JP)

(21) Appl. No.: 19/042,018

(22) Filed: Jan. 31, 2025

(30) Foreign Application Priority Data
Apr. 11, 2024 (JP) 2024-063983

(51) Int. Cl. G07C 9/00; H01Q 1/32

(52) U.S. Cl. CPC G07C 9/00944; G07C 9/00309; H01Q 1/3233

(57) ABSTRACT

When the first antenna receives a signal from the electronic key and the second antenna receives a signal from the electronic key, the execution device determines that the electronic key is located in the interior of the vehicle. When one of the first antenna and the second antenna receives the signal from the electronic key, the execution device determines that the electronic key is not located in the interior of the vehicle. The execution device determines that the electronic key is located in the interior of the vehicle when the third antenna receives a signal from the electronic key, even if either the first antenna or the second antenna receives a signal from the electronic key.

### CROSS-REFERENCE TO RELATED APPLICATION

This application claims priority to Japanese Patent Application No. 2024-063983 filed on Apr. 11, 2024, incorporated herein by reference in its entirety.

### BACKGROUND

### 1. Technical Field

The present disclosure relates to a vehicle.

### 2. Description of Related Art

Japanese Unexamined Patent Application Publication No. 2004-084406 (JP 2004-084406 A) describes a vehicle including a first antenna that receives a signal from an electronic key, a second antenna that receives a signal from the electronic key, and a control device that includes a determination unit that determines whether the electronic key is located in a cabin.

The first antenna is located at a right door. The second antenna is located at a left door. When both the first antenna and the second antenna receive a signal from the electronic key, the determination unit determines that the electronic key is located in the cabin. When either of the first antenna and the second antenna receives a signal from the electronic key, the determination unit determines that the electronic key is not located in the room.

### SUMMARY

In a vehicle such as that described in JP 2004-084406 A, the determination unit may determine that the electronic key is not located in the cabin, in spite of the fact that the electronic key is located in the cabin, when only two antennas are used, depending on the size, shape, or the like of the vehicle.

In order to address the above issue, an aspect of the present disclosure provides a vehicle including a first antenna that receives a signal from an electronic key, a second antenna that receives a signal from the electronic key, a third antenna that receives a signal from the electronic key, a control device that includes a determination unit that determines whether the electronic key is located in a cabin, a left door in which the first antenna is located, and a right door in which the second antenna is located, in which:
the third antenna is located between the first antenna and the second antenna in a right-left direction of a vehicle body, and is located on a front side of the first antenna and the second antenna in a front-rear direction of the vehicle body; and
the determination unit performs determination control in which
it is determined that the electronic key is located in the cabin when both the first antenna and the second antenna receive a signal from the electronic key,
it is determined that the electronic key is not located in the cabin when either of the first antenna and the second antenna receives a signal from the electronic key, and
it is determined that the electronic key is located in the cabin when the third antenna receives a signal from the electronic key, even if either of the first antenna and the second antenna receives a signal from the electronic key.

The above vehicle can suppress the determination unit erroneously determining that the electronic key is not located in the cabin of the vehicle, in spite of the fact that the electronic key is located in the cabin of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a top view showing the position of an antenna in a vehicle body of a vehicle;

FIG. 2 is a side view showing a vehicle body of a vehicle;

FIG. 3 is a schematic diagram illustrating a vehicle;

FIG. 4 is a flow chart showing a series of processes of determination control; and

FIG. 5 is a flowchart illustrating a series of processes of the start control.

### DETAILED DESCRIPTION OF EMBODIMENTS

### Embodiment

### Outline of Vehicle

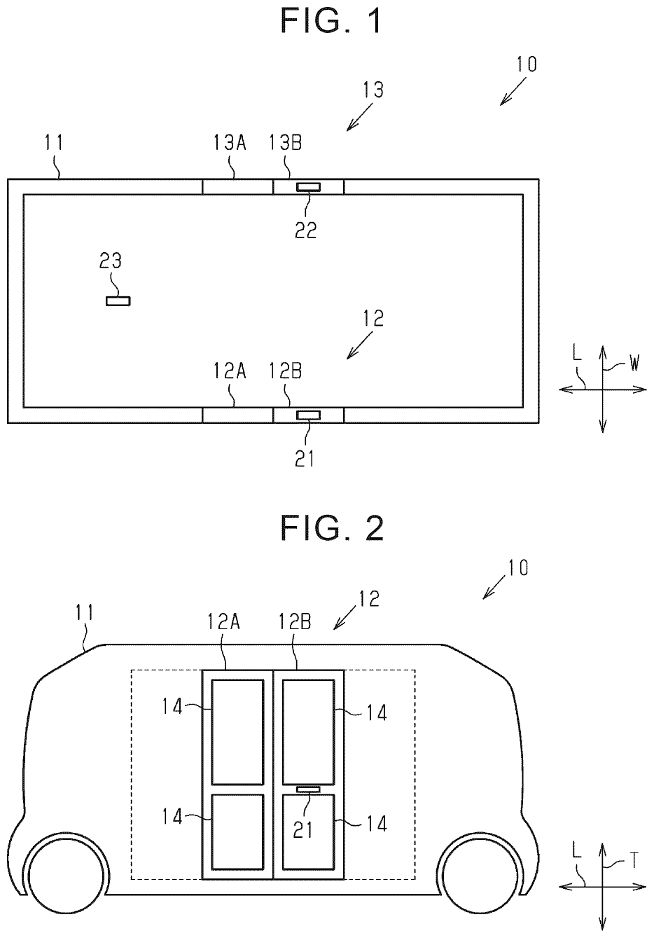

Hereinafter, an embodiment of a vehicle will be described with reference to the drawings. As illustrated in FIG. 1, the vehicle 10 includes a vehicle body 11. The space in the interior of the vehicle body 11 is about twice as large as the dimension in the left-right direction W in the front-rear direction L. The vehicle body 11 includes a left door 12 and a right door 13. The left door 12 opens and closes the opening of the left side wall of the vehicle body 11 in the left-right direction W of the vehicle body 11. The left door 12 is located substantially in the center in the front-rear direction L of the vehicle body 11 in a closed state in which the opening is closed.

As shown in FIG. 2, the left door 12 has a first left door 12A and a second left door 12B. The first left door 12A and the second left door 12B are arranged in the front-rear direction L of the vehicle body 11. The first left door 12A is located in front of the second left door 12B. The first left door 12A is slidable in the front-rear direction L of the vehicle body 11. The first left door 12A opens and closes the front half of the opening of the left side wall of the vehicle body 11. The second left door 12B is slidable in the front-rear direction L of the vehicle body 11. The second left door 12B opens and closes the rear half of the opening of the left side wall of the vehicle body 11. The first left door 12A and the second left door 12B each have two window glasses 14 arranged in the up-down direction T of the vehicle body 11.

As illustrated in FIG. 1, the right door 13 opens and closes an opening of a right side wall of the vehicle body 11 in the left-right direction W of the vehicle body 11. The right door 13 is located substantially in the center in the front-rear direction L of the vehicle body 11 in a closed state in which the opening is closed.

The right door 13 has a first right door 13A and a second right door 13B. The first right door 13A and the second right door 13B are arranged in the front-rear direction L of the vehicle body 11. The first right door 13A and the second right door 13B are arranged in the front-rear direction L of the vehicle body 11. The first right door 13A is located on the front side of the second right door 13B. The first right door 13A is slidable in the front-rear direction L of the vehicle body 11. The first right door 13A opens and closes the front half of the opening of the right-side wall of the vehicle body 11. The second right door 13B is slidable in all directions of the vehicle body 11. The second right door 13B opens and closes the rear half of the opening of the right-side wall of the vehicle body 11. The first right door 13A and the second right door 13B each have two window glasses 14 arranged in the up-down direction T of the vehicle body 11.

The vehicle 10 includes a first antenna 21, a second antenna 22, and a third antenna 23.

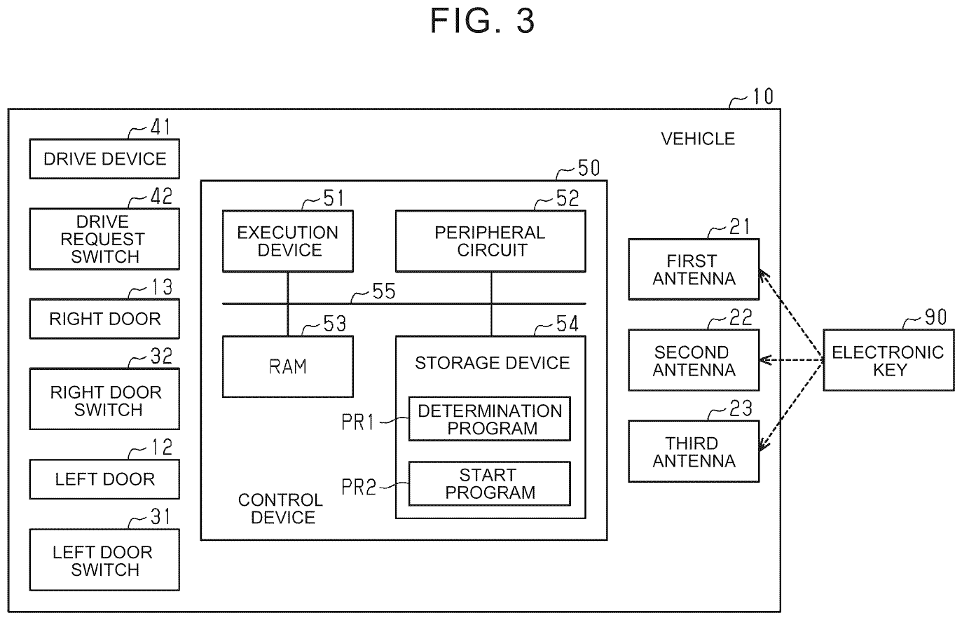

As shown in FIG. 3, the first antenna 21, the second antenna 22, and the third antenna 23 are capable of receiving signals from the electronic keys 90 of the vehicle 10. Each antenna receives a signal from the electronic key 90 when the distance to the electronic key 90 is less than a predetermined distance. Each antenna transmits a radio wave indicating a request to transmit a signal to the electronic key 90.

As shown in FIG. 1, the first antenna 21 is built into the second left door 12B. As shown in FIG. 2, the first antennae 21 are positioned between the two window glasses 14 of the second left door 12B in the up-down direction T. The first antenna 21 receives signals from the electronic key 90 located within a prescribed distance from the left door 12 of the interior of the vehicle 10, a portion of the front half of the interior of the vehicle 10, and the exterior of the vehicle 10.

As shown in FIG. 1, the second antennae 22 are built into the second right door 13B. Although not shown, the second antennae 22 are positioned between the two window glasses 14 of the second right door 13B in the up-down direction T. The second antenna 22 receives signals from the rear side half of the interior of the vehicle 10, a portion of the front side half of the interior of the vehicle 10, and an electronic key 90 located within a defined distance from the right door 13 of the exterior of the vehicle 10.

The third antenna 23 is located between the first antenna 21 and the second antenna 22 in the left-right direction W of the vehicle body 11. Specifically, the third antenna 23 is located at the center in the left-right direction W of the vehicle body 11. The third antenna 23 is located on the front side of the first antenna 21 and the second antenna 22 in the front-rear direction L of the vehicle body 11. Specifically, the third antenna 23 is located on the front side of the center of the vehicle body 11 in the front-rear direction L. The third antenna 23 receives a signal from the electronic key 90 located in the front half of the interior of the vehicle 10.

As illustrated in FIG. 3, the vehicle 10 includes a left door switch 31 and a right door switch 32. The left door switch 31 is provided on the left door 12. The left door switch 31 is operated when the left door 12 is in the open state, so that an actuator (not shown) shifts the left door 12 from the open state to the closed state. The left door switch 31 is operated when the left door 12 is in the closed state, so that an actuator (not shown) shifts the left door 12 from the closed state to the open state.

The right door switch 32 is provided on the right door 13. The right door switch 32 is operated when the right door 13 is in the open state, so that an actuator (not shown) shifts the right door 13 from the open state to the closed state. Further, the right door switch 32 is operated when the right door 13 is in the closed state, so that an actuator (not shown) shifts the right door 13 from the closed state to the open state.

The vehicle 10 includes a drive device 41, a drive request switch 42, and a control device 50. The drive device 41 is driven to enable the vehicle body 11 to travel. The drive device 41 is, for example, an engine.

The drive request switch 42 is operated to output a start request of the drive device 41 to the control device 50. The control device 50 determines whether the electronic key 90 is located in the interior of the vehicle 10, and controls the drive device 41. That is, in the present embodiment, the control device 50 includes a determination unit and a control unit.

The control device 50 includes an execution device 51 that is a CPU, peripheral circuit 52, a RAM 53, a storage device 54, and a bus 55. The bus 55 communicatively connects the execution device 51, the peripheral circuit 52, RAM 53, and the storage device 54 to each other. The execution device 51 performs information processing by executing various programs stored in the storage device 54. The peripheral circuit 52 includes a circuit that generates a clock signal that defines an internal operation, a power supply circuit, a reset circuit, and the like. RAM 53 stores information generated when the execution device 51 performs information processing. The storage device 54 stores a determination program PR1 for performing determination control for determining whether the electronic key 90 is located in the interior of the vehicle 10, and start program PR2 for performing start control of the drive device 41. Further, the storage device 54 stores information indicating a flag indicating position information of the electronic key 90.

The execution device 51 determines whether the electronic key 90 is located outside the vehicle 10 by using the first antenna 21 and the second antenna 22. For example, when the left door switch 31 or the right door switch 32 is operated, the execution device 51 determines whether the electronic key 90 is located outside the vehicle 10. When only one of the first antenna 21 and the second antenna 22 receives the signal from the electronic key 90, the execution device 51 determines that the electronic key 90 is located outside the vehicle 10.

### Determination Control of Whether an Electronic Key is Located in a Room

When at least one of the left door 12 and the right door 13 changes from the open state to the closed state, the execution device 51 starts execution of the determination program PR1.

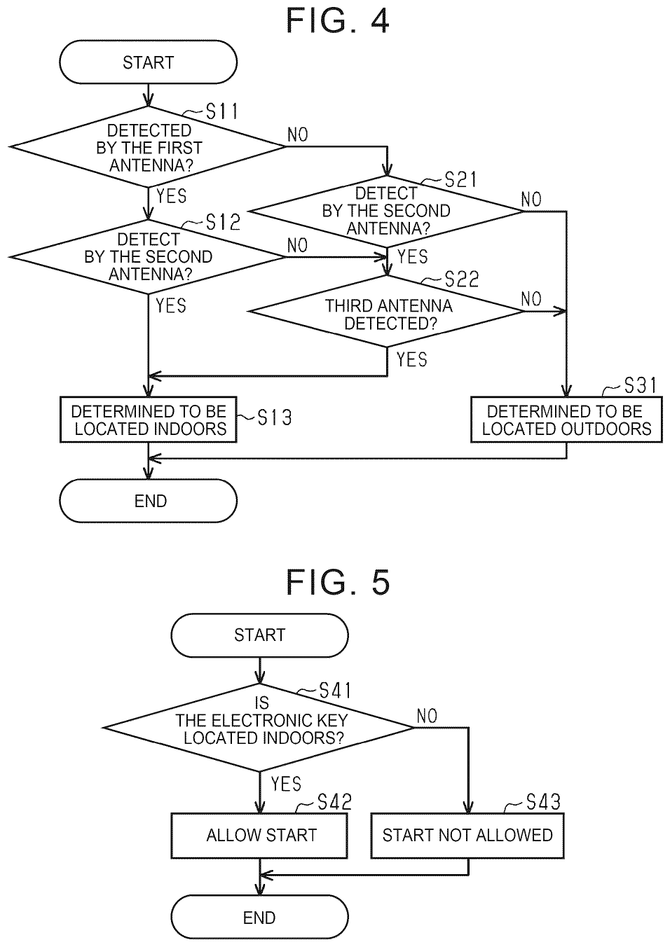

As illustrated in FIG. 4, when the execution device 51 starts execution of the determination program PR1, the execution device 51 first performs a S11 process. In S11, the execution device 51 determines whether the electronic key 90 is detected by the first antenna 21. Specifically, when the first antenna 21 receives a signal from the electronic key 90 in a prescribed period, the execution device 51 determines that the electronic key 90 is detected by the first antenna 21. When the first antenna 21 does not receive the signal from the electronic key 90 in the predetermined period, the execution device 51 determines that the electronic key 90 is not detected by the first antenna 21. The prescribed period is defined as a period in which the first antenna 21 can receive a signal from the electronic key 90 after emitting a radio wave requesting transmission of a signal to the electronic key 90. The prescribed period is, for example, 1 second. When it is detected by the first antenna 21 (S11: YES), the execution device 51 advances the process to S12.

In S12, the execution device 51 determines whether the electronic key 90 is detected by the second antenna 22. Specifically, when the second antenna 22 receives a signal from the electronic key 90 in a prescribed period, the execution device 51 determines that the electronic key 90 is detected by the second antenna 22. When the second antenna 22 does not receive the signal from the electronic key 90 in the predetermined period, the execution device 51 determines that the electronic key 90 is not detected by the second antenna 22. When detected by the second antennae 22 (S12: YES), the execution device 51 advances the process to S13.

In S13, the execution device 51 determines that the electronic key 90 is located in the interior of the vehicle 10. Then, the execution device 51 sets the flag indicating the position information of the electronic key 90 in the storage device 54 to a state indicating that the flag is located in the room. When the execution device 51 makes an affirmative determination on S11 and makes an affirmative determination on S12 to perform S13, both the first antenna 21 and the second antenna 22 receive the signal from the electronic key 90. That is, when both of the first antenna 21 and the second antenna 22 receive the signal from the electronic key 90, the execution device 51 determines that the electronic key 90 is located in the interior of the vehicle 10. Thereafter, the execution device 51 ends the series of processes of the current determination control.

On the other hand, when not detected by the first antenna 21 (S11: NO), the execution device 51 advances the process to S21. In S21, similarly to S12, the execution device 51 determines whether the electronic key 90 is detected by the second antenna 22. When the electronic key 90 is not detected by the second antenna 22 (S21: NO), the execution device 51 advances the process to S31.

In S31, the execution device 51 determines that the electronic key 90 is located outside the vehicle 10. That is, the execution device 51 determines that the electronic key 90 is not located in the interior of the vehicle 10. Then, the execution device 51 sets the flag indicating the position information of the electronic key 90 in the storage device 54 to a state indicating that the flag is not located in the room. When the execution device 51 makes a negative determination in S11 and makes a negative determination in S21 to perform S31, neither the first antenna 21 nor the second antenna 22 has received the signal from the electronic key 90. That is, when neither the first antenna 21 nor the second antenna 22 receives the signal from the electronic key 90, the execution device 51 determines that the electronic key 90 is not located in the interior of the vehicle 10. Thereafter, the execution device 51 ends the series of processes of the current determination control.

When the electronic key 90 is not detected by the second antenna 22 after the execution device 51 makes an affirmative determination by S11 (S12: NO), the execution device 51 advances the process to S22. Alternatively, when the electronic key 90 is detected by the second antenna 22 after the execution device 51 makes a negative determination by S11 (S21: YES), the execution device 51 advances the process to S22.

In S22, the execution device 51 determines whether the electronic key 90 is detected by the third antenna 23. Specifically, when the third antenna 23 receives a signal from the electronic key 90 in a prescribed period, the execution device 51 determines that the electronic key 90 is detected by the third antenna 23. When the third antenna 23 does not receive the signal from the electronic key 90 in the predetermined period, the execution device 51 determines that the electronic key 90 is not detected by the third antenna 23. When the electronic key 90 is detected by the third antenna 23 (S22: YES), the execution device 51 advances the process to S13. When the execution device 51 performs S13 process via S22, the third antenna 23 receives the signal from the electronic key 90 even if either the first antenna 21 or the second antenna 22 receives the signal from the electronic key 90. That is, the execution device 51 determines that the electronic key 90 is located in the interior of the vehicle 10 when the third antenna 23 receives a signal from the electronic key 90 even if any one of the first antenna 21 and the second antenna 22 receives a signal from the electronic key 90. Thereafter, the execution device 51 ends the series of processes of the current determination control.

On the other hand, when the electronic key 90 is not detected by the third antenna 23 (S22: NO), the execution device 51 advances the process to S31. When the execution device 51 performs S31 process via S22, the third antenna 23 has not received the signal from the electronic key 90, and either the first antenna 21 or the second antenna 22 has received the signal from the electronic key 90. That is, when the third antenna 23 has not received the signal from the electronic key 90 and either the first antenna 21 or the second antenna 22 has received the signal from the electronic key 90, the execution device 51 determines that the electronic key 90 is not located in the interior of the vehicle 10. Thereafter, the execution device 51 ends the series of processes of the current determination control. In this way, in the control device 50, the execution device 51 executes the determination program PR1 to constitute a determination unit.

### Vehicle Start Control

As shown in FIG. 3, when the execution device 51 acquires the start request of the drive device 41 from the drive request switch 42, the execution device 51 starts execution of the start program PR2.

As shown in FIG. 5, when the execution device 51 starts execution of the start program PR2, S41 process is performed first. In S41, the execution device 51 determines whether the electronic key 90 is located in the interior of the vehicle 10. Specifically, the execution device 51 refers to a flag indicating the position information of the electronic key 90 of the storage device 54. When the flag indicates that the electronic key 90 is located in the interior of the vehicle 10, the execution device 51 determines that the electronic key 90 is located in the interior of the vehicle 10. When the flag indicates that the electronic key 90 is not located in the interior of the vehicle 10, the execution device 51 determines that the electronic key 90 is not located in the interior of the vehicle 10. When the electronic key 90 is located in the interior of the vehicle 10 (S41: YES), the execution device 51 advances the process to S42.

In S42, the execution device 51 permits the starting of the drive device 41. Then, the execution device 51 starts starting the drive device 41. Thereafter, the execution device 51 terminates a series of processes of the start-up control of the drive device 41.

On the other hand, when the electronic key 90 is not located in the interior of the vehicle 10 (S41: NO), the execution device 51 advances the process to S43. In S43, the execution device 51 does not allow the starting of the drive device 41. Therefore, the execution device 51 does not start the drive device 41. Thereafter, the execution device 51 terminates a series of processes of the start-up control of the drive device 41.

### Operations of Embodiment

For example, it is assumed that the user holding the electronic key 90 gets into the vehicle 10 and starts traveling of the vehicle 10. In this case, the user moves the right door 13 of the vehicle 10 from the closed state to the open state by operating the right door switch 32. Next, after getting into the interior of the vehicle 10, the user shifts the right door 13 from the open state to the closed state. At this time, the control device 50 performs determination control when the right door 13 is changed from the open state to the closed state. Since the user holds the electronic key 90, both the first antenna 21 and the second antenna 22 are detected, or the third antenna 23 is detected, so that the control device 50 determines that the electronic key 90 is located in the interior of the vehicle 10. Next, the user activates the drive device 41 by operating the drive request switch 42. At this time, the control device 50 acquires the start request from the drive request switch 42, thereby performing the start control of the drive device 41.

Further, for example, it is assumed that the user holding the electronic key 90 gets off the vehicle 10. In this case, the user moves the right door 13 of the vehicle 10 from the closed state to the open state by operating the right door switch 32. Next, after the user gets out of the vehicle 10, the user shifts the right door 13 from the open state to the closed state. At this time, the control device 50 performs determination control when the right door 13 is changed from the open state to the closed state. Since the user holds the electronic key 90, the first antenna 21 is not detected, the second antenna 22 is detected, and the third antenna 23 is not detected, so that the control device 50 determines that the electronic key 90 is not located in the interior of the vehicle 10.

Here, it is assumed that the electronic key 90 is located in the front half of the interior of the vehicle 10. In this case, of the first antenna 21 and the second antenna 22, only one of the first antenna 21 and the second antenna 22 may receive a signal from the electronic key 90. When the electronic key 90 is located in the front half of the interior of the vehicle 10, according to the above embodiment, the third antenna 23 receives a signal from the electronic key 90.

### Effects of Embodiment

(1) The control device 50 determines that the electronic key 90 is located in the interior of the vehicle 10 when the third antenna 23 receives a signal from the electronic key 90 even if any one of the first antenna 21 and the second antenna 22 receives a signal from the electronic key 90. Therefore, depending on the size, shape, and the like of the vehicle 10, in the interior of the vehicle 10, there may be a range in which one of the first antenna 21 and the second antenna 22 cannot receive a signal from the electronic key 90 located in the interior of the vehicle 10. Even in this case, the third antenna 23 can receive a signal from the electronic key 90 located in the interior of the vehicle 10 located in the range. Therefore, according to the control device 50 of the above-described embodiment, it is possible to prevent erroneous determination that the electronic key 90 is not located in the interior of the vehicle 10 even though the electronic key 90 is located in the interior of the vehicle 10.

(2) According to the above-described embodiment, the control device 50 performs the determination control when at least one of the left door 12 and the right door 13 is changed from the open state to the closed state. A situation in which at least one of the left door 12 and the right door 13 changes from the open state to the closed state is a situation in which the positions of the user of the vehicle 10 and the electronic key 90 are easily changed. Therefore, the control device 50 can perform the determination control in accordance with the timing at which the necessity of determining the position of the electronic key 90 is high.

(3) According to the above embodiment, the control device 50, the electronic key 90 is determined to be located in the room, and when there is a start request by the drive request switch 42 is operated, to permit the start of the drive device 41. That is, in the present embodiment, the control device 50 uses the determination result by the determination control to determine whether to permit the start of the drive device 41. Thus, when the electronic key 90 is not located in the room, it is possible to not allow the start of the drive device 41.

(4) The first antenna 21 and the second antenna 22 are used to determine whether the electronic key 90 is located outside the vehicle 10 when the left door switch 31 is operated. The first antenna 21 and the second antenna 22 used in this way are easily provided so as to emit a radio wave for requesting transmission of a signal to the electronic key 90 toward the outside of the vehicle 10. Therefore, when detecting that the first antenna 21 and the second antenna 22 are located in the interior of the vehicle 10, the radio waves from the first antenna 21 and the second antenna 22 are easily blocked by the vehicle body 11, so that the detection range in the interior is smaller than that in the exterior. Therefore, if the first antenna 21 and the second antenna 22 are provided in a panel without the window glass 14 or a panel with only one window glass 14, it is difficult for the control device 50 to affirmatively determine both S11 and S12 processes due to the narrow detection area in the room.

According to the above-described embodiment, the first antenna 21 is positioned between the two window glasses 14 on the second left door 12B in the up-down direction T of the vehicle body 11. The second antenna 22 is located between the two window glasses 14 on the second right door 13B in the up-down direction T of the vehicle body 11. Radio waves requesting a signal from each antenna to the electronic key 90 are less likely to be blocked by the window glass 14 of the vehicle body 11 than, for example, a metal portion. Therefore, the first antenna 21 can set the detection range to a correspondingly wide range in the interior of the vehicle 10. Therefore, the determination control can be realized by positioning the first antenna 21 and the second antenna 22 in the door having the two window glasses 14.

### OTHER EMBODIMENTS

The present embodiment can be realized with the following modifications. The present embodiment and the following modifications can be combined with each other within a technically consistent range to be realized.

The left door 12 may omit the first left door 12A. The second left door 12B may not have two window glasses 14. Even if the second left door 12B has only one window glass 14, if it is correspondingly large, the radio waves of the first antennae 21 can sufficiently leak into the interior of the vehicle 10. Further, the second left door 12B need not include the window glass 14 as long as the detection area in the interior of the vehicle 10 is correspondingly large because the radio waves of the first antenna 21 are correspondingly received in the room. The same applies to the right door 13.

The control device 50 may not use the determination result by the determination control for the start control of the drive device 41. That is, the control device 50 may not execute the start program PR2. That is, the control device 50 may not include the control unit.

The control device 50 may use the determination result by the determination control for a warning for preventing the electronic key 90 from being left behind. For example, when the left door 12 changes from the open state to the closed state, the user may leave the vehicle 10. At this time, in the determination result of the determination control, when it is determined that the electronic key 90 is located in the interior of the vehicle 10, the control device 50 may output a warning from a speaker or the like of the vehicle 10.

The timing at which the control device 50 performs the determination control may not be when at least one of the left door 12 and the right door 13 is changed from the open state to the closed state. For example, the timing at which the control device 50 performs the determination control may be when the vehicle 10 has another door and the other door changes from the open state to the closed state. Further, for example, the timing at which the control device 50 performs the determination control may be a time at which at least one of the left door 12 and the right door 13 changes from the closed state to the open state. Further, for example, regardless of the state of the door, the control device 50 may repeatedly perform the determination control at predetermined intervals.

The electronic key 90 may be a digital key. In this case, a signal transmitted by the portable terminal storing the digital key is a signal from the electronic key 90.

What is claimed is:

1. A vehicle comprising a first antenna that receives a signal from an electronic key, a second antenna that receives a signal from the electronic key, a third antenna that receives a signal from the electronic key, a control device that includes a determination unit that determines whether the electronic key is located in a cabin, a left door in which the first antenna is located, and a right door in which the second antenna is located, wherein:
the third antenna is located between the first antenna and the second antenna in a right-left direction of a vehicle body, and is located on a front side of the first antenna and the second antenna in a front-rear direction of the vehicle body; and
the determination unit performs determination control in which
it is determined that the electronic key is located in the cabin when both the first antenna and the second antenna receive a signal from the electronic key,
it is determined that the electronic key is not located in the cabin when either of the first antenna and the second antenna receives a signal from the electronic key, and
it is determined that the electronic key is located in the cabin when the third antenna receives a signal from the electronic key, even if either of the first antenna and the second antenna receives a signal from the electronic key.

2. The vehicle according to claim 1, wherein the determination unit performs the determination control when a door of the vehicle is brought from an open state to a closed state.

3. The vehicle according to claim 1, further comprising a drive request switch that is operated to output a start request for a drive device of the vehicle to the control device, wherein:
the control device further includes a control unit that controls the drive device; and
the control unit is configured
not to permit start of the drive device when it is determined by the determination unit that the electronic key is not located in the cabin and the start request is made by operating drive request switch, and
to permit start of the drive device when it is determined by the determination unit that the electronic key is located in the cabin and the start request is made by operating the drive request switch.

4. The vehicle according to claim 1, wherein:
the right door has two window glasses arranged in an up-down direction of the vehicle body;
the first antenna is located between the two window glasses of the right door in the up-down direction;
the left door has two window glasses arranged in the up-down direction; and
the second antenna is located between the two window glasses of the left door in the up-down direction.
